(19) United States
(12) Patent Application Publication
(10) Pub. No.: US 2022/0204895 A1
(43) Pub. Date: Jun. 30, 2022

(54) Method for producing malt

(71) Applicant: WATER IQ INTERNATIONAL B.V., Eindhoven (NL)

(72) Inventors: Freddy DEKKERS, Eindhoven (NL); Irina BOLAT, Eindhoven (NL); Koenraad DUMONT, Eindhoven (NL)

(21) Appl. No.: 17/594,872

(22) PCT Filed: May 2, 2020
(86) PCT No.: PCT/NL2020/050279

§ 371 Date: Nov. 2, 2021

(30) Foreign Application Priority Data
May 2, 2019 (NL) 2023053

(51) Int. Cl. C12C 1/02; C02F 1/28; C02F 1/72

(52) U.S. Cl. CPC C12C 1/02; C02F 1/727; C02F 1/725; C02F 1/281

(57) ABSTRACT

Malt is produced from cereals via steeping followed by germination and kilning. The steeping process comprises only one prolonged immersion step during which the steeping water is continuously purified. This insures a continuous conditioning and recirculation of water into the steeping vessel. The conditioned water has a lower pollution rate, an improved oxygenation level and supports a good water uptake by the grain via the embryo. At the same time the microbial load brought by the grain from the farm is being reduced, with positive consequences on the availability of oxygen towards the grain rather than being consumed by the microflora of the grain. This method brings up to 40% water savings in the steeping process by conditioning the water used in this step, improving the grain water uptake and the oxygen availability for the grain, as well as having a positive impact on the quality of the final malt with regards to some characteristics essential for the flavour and foam stability of the final beer.

### TECHNICAL FIELD OF THE INVENTION

The invention relates to method for producing malt from cereals via steeping followed by germination and kilning, the steeping process comprises only one immersion step in which the cereals are immersed in water, during which immersion step the steeping water is continuously purified.

The traditional malting process is defined as a three step process: steeping-germination-kilning. The steeping process implies immersing the grain under water for a number of hours followed by removing the water with an air rest period. A second immersion takes place as well as a second air rest phase before the malt is transferred into the germination box.

The goal of germination is to continue to produce enzyme inside the grain able to degrade all the rigid structures of the cereal, making it easy to use in food and beverage processes.

### Background of the Invention

Grains can be used in beverages and foods as such or as malted cereals. Due to its high enzymatic content malt is better suited as fermentation substrate as well as for adding flavour and nutrients into the foods and beverages it is being added. From the total malt produced in the world 96% is used in beer production, approximately 3% in distilling industry, while the rest finds its application in food industry like breakfast cereals, malted drinks.

Several types of cereals can be malted such as barley, sorghum, wheat, rye, with a strong preference towards malted barley for the brewing industry due to the presence of husk and high enzymatic activity that allows the transformation of starch in fermentable sugars.

Barley is the fourth cereal in terms of volume produced per year in the world. It has a very good adaptability, with crops grown over a wide range of environmental conditions. A good proportion of barley production (35%) is used for food, brewing and distilling, with the rest of the volume being used either as feed (60%) or seeds (5%).

Barley used in food industries is mainly malted and sold as malted barley. The malting process comprises 3 main steps: steeping, germination and kilning, transforming barley into malt that is easily processed in the food and beverage industry due its high enzymatic content, easily accessible pool of fermentable sugars and valuable nitrogen content.

The average amount of water used for malt production with a traditional system ranges between 3.5 m³/t but it can go up to 6 m³/t in function of the method applied.

The scarcity of fresh water around the world brings the need for more efficient solutions for water savings. It is estimated that by 2025 two-thirds of the world's population may face water shortages.

Malt production implies the promotion of grain germination under controlled conditions, followed by a complete stop of its metabolic activity by drying it at high temperature and reducing the moisture content.

Traditionally, the production of malted hulled cereals involves 2 or 3 immersions of the hulled grains in fresh water with the subsequent removal of the steeped liquor to the drain. In this way the embryo is being hydrated, a plethora of enzymes start to be synthesized by the aleuronic layer and the plant growth is being promoted. These wet phases are separated by dry phases, when the grain is being exposed to the atmosphere, to avoid the build-up of carbon dioxide during the steep and allow the water uptake by the grain from 12-14% moisture in the intake grain to 42-43% in green malt. During each wet phase, air is being sparged in the steeping vessels, to support the metabolism of the grain while carbon dioxide is extracted, removing the build-up of this compound and avoiding fermentation. The steeping phase represents the biggest water consumer step in the malting process.

There are a number of factors that influence the water uptake into the grain: corn size, hardness of the kernel expressed as level of β-glucans in the endosperm, cell wall composition, endosperm structure, dormancy and water sensitivity. The last two factors can be overcome by insuring a good supply of oxygen to the grain during the steeping phase.

The water is being taken up by the grain through the areas that lack the peripheral layers of cuticle, like the embryo and the upper tip of the corn in case of the hulled grain. Inside the kernel water gives the signal for the degradation enzymes to be synthesized and the hydrolytic processes start transforming substrate material into biologically active compounds that promote the growth of the plant. Respiration of the grain increases swiftly as the corn is wetted, with oxygen being rapidly consumed. In case of an insufficient supply of oxygen, the grain will start to produce carbon dioxide and alcohol which may inhibit germination. If the steeping liquor is continuously aerated both oxygen consumption and carbon dioxide production increases. The main parts of the grain that show profound respiration are the embryo and the rootlets, while the endosperm is the area responsible for amylase production with limited respiration.

The importance of oxygen during steeping for a good germinative capacity has been widely studied and in particular the delayed germination in case of reduced oxygen levels in case long steeping times (when the grain is under water) are employed. The traditional steeping process overcomes this issue by draining the steep liquor and including periods of “air-rest”, simulating conditions in the soil. During these dry periods the activity of the main enzymes responsible for degrading the hard matrix of the grain increases significantly, grain respiration is very active and the temperature of the grain bed increases very fast. While this method allows a good processability of the grains, it also brings large amounts of waste water due to repeated wet phases employed. During the wet phase of the steep 1% of the dry weight of the grain is leaching from the grain into the steeping water making a perfect medium for the development of bacteria and fungi. By changing the steeping liquor only 50% of the leached compounds are being removed.

Other methods have been tested to reduce water consumption in steeping while keeping a good quality of the malt produced, such as a single, continuous 24h steeping regime without air-rest periods in between with spray-steeping or re-use of the steeping liquor from one steep to a subsequent batch as well as reverse osmosis. In case of the re-use of the steeping liquor high concentrations of acetic and other acids coming from the microflora of the grain bring an inhibitory effect upon germination. This is one of the reasons this practice is not commonly used by maltsters.

A method for producing malt according to the preamble of claim 1 is known from WO 2019/048338 A1. This known method insures a continuous conditioning and circulation of water into the steeping vessel. The conditioned water has a lower pollution rate, an improved oxygen level and supports a good water uptake by the grain via the embryo. At the same time the microbial load brought by the grain from the farm is being reduced, with positive consequences on the availability of oxygen towards the grain rather than being consumed by the microflora of the grain.

The continuous recirculation keeps the barley always in contact with water, avoiding both dry spots and hot spots that might appear in the traditional process.

The known method brings up water savings in the steeping process by conditioning the water used in this step, improving the grain water uptake and the oxygen availability for the grain, as well as having a positive impact on the quality of the final malt with regards to some characteristics essential for the flavour and foam stability of the final beer.

At the end of the steeping phase the corn is being transferred into the germination vessel. The germination itself starts already in the steeping phase and continues for several days in the germination boxes. During this phase the endosperm modification continues, the cell walls are being degraded, the proteins are being hydrolysed and the starch granules are being released from the protein matrix making them available for the enzymatic attack needed to insure the pool of fermentable sugars.

### SUMMARY OF THE INVENTION

It is an object of the present invention to improve the known method for producing malt, more particularly to improve the quality of the final malt with respect to the known method. To this end the method for producing malt according to the invention is characterized in that the purification comprises an adsorption process followed by an oxidation process, which adsorption process purifies the steeping water using a carrier material having a ceramic open structure to enable binding of non-charged polymeric organic molecules including a fraction of the polyphenolic compounds and molecular compounds leaking from the grain in the water, and which oxidation process comprising injection of hydrogen peroxide and high concentrated oxygen into the water after the adsorption process and using a ceramic filter bed as carrier material with an immobilized catalyst on it for removing micro-organisms, which catalyst comprises a complex of metal ions. The complex of metal ions preferably comprises one or more of the following ions: copper, iron, cobalt, palladium. This ensures the reduction of the bacterial and fungal load in the steeping water via the advanced oxidation column, reducing as such the risk of acidic compounds. Due to the heavy pollution of the steeping water, known oxidation processes for purifying water will not be sufficient to purify the water. Therefore, the steeping water will be contacted with ceramic material with an immobilized catalyst on it.

Moreover, the removal of polyphenols and other compounds that are leaking from the grain into the water during steeping are being partially removed through the adsorption step, keeping the pH of the steeping water on the neutral side. In case of the traditional steeping process the pH values of the steeping liquor decreases due to the presence of acids dissolved from the grain.

In order to improve the oxidation process, the water enters at least one oxidation column containing the ceramic filter bed with the immobilized catalyst via a perforated injection tube extending vertically upwards in the oxidation column. This ensures that there is good contact between the water on one hand and the ceramic material and catalyst on the other hand.

### BRIEF DESCRIPTION OF THE DRAWINGS

The invention will be further elucidated below on the basis of drawings. These drawings show an embodiment of a system for performing the method according to the present invention. In the drawings:

FIG. 1 is a schematic representation of a system; and

FIG. 2 is a perspective view of the system shown in FIG. 1.

### DETAILED DESCRIPTION OF THE DRAWINGS

The traditional malting process is defined as a three step process: steeping-germination-kilning. The steeping process implies immersing the grain under water for a number of hours followed by removing the water with an air rest period. A second immersion takes place as well as a second air rest phase before the malt is transferred into the germination box.

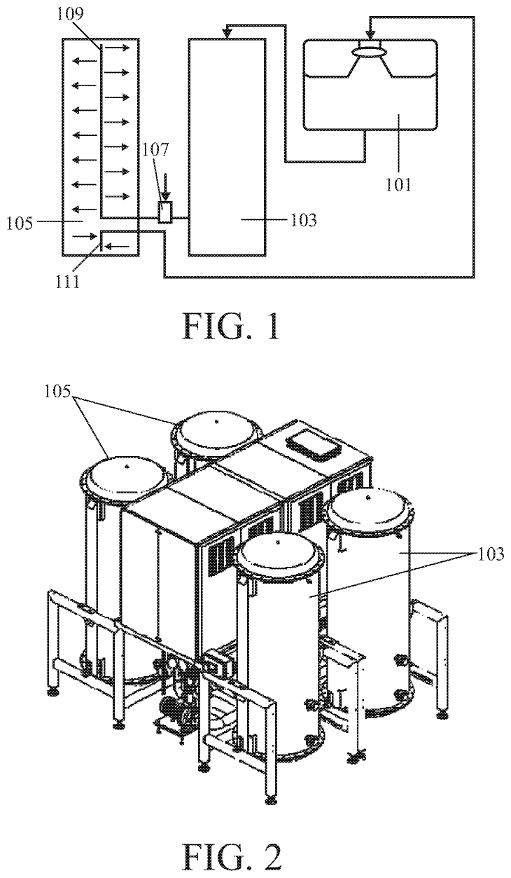

The method according to the invention allows the use of only one immersion of the grain in a steeping vessel 101 (see FIGS. 1 and 2) in the same amount of water as any of the wet phases from the traditional method. The water is being continuously conditioned via the new system that employs two steps: adsorption and advanced oxidation.

The steeping water is purified in a two step process. The first step is a selective adsorption. In this step, substances are adsorbed in adsorption columns 103 filled with ceramic carrier material. The adsorption process enables selective purification of the water and uses a carrier material having a ceramic open structure to enable binding of non-charged polymeric organic molecules, comparable to the working principle of granular activated carbon. This includes a fraction of the polyphenolic compounds. During the adsorption phase the level of polyphenols and molecular compounds leaking from the grain in the water are being removed via an adsorption step. Without this reduction in biological load of the steeping water, the steeping liquor would represent a perfect medium for microorganisms brought by the barley from the field to thrive, using up the oxygen in the water and reducing the pH level.

This water goes further into the second step which is a treatment based on advanced oxidation in oxidation columns 105. This step removes micro-organisms. Hydroxylradicals are formed with a catalyst induced advanced oxidation. Oxidants hydrogen peroxide (liquid) and high concentrated oxygen (gas) is injected 107 in the water flow after the adsorption. The catalyst is immobilized on the carrier material, a ceramic filter bed. The catalyst, which consists of a complex of metal ions, like copper, iron, cobalt, palladium, and oxidants produce the radicals (OH* and O₂—) that react with micro-organisms and soluble organic pollution. These radicals insure a good disinfection of the water before going back into the steeping vessel. The water entering the oxidation columns via a perforated injection tube 109 extending vertically upwards in the columns and leaving the oxidation columns via a perforated drainage tube 111.

The novel system insures thus a continuous conditioning and circulation of water into the steeping vessel 101 of up to 20 hrs. The conditioned water has a lower pollution rate, an improved oxygen level and supports a good water uptake by the grain via the embryo. At the same time the microbial load brought by the grain from the farm is being reduced, with positive consequences on the availability of oxygen towards the grain rather than being consumed by the microflora of the grain.

The continuous circulation keeps the barley always in contact with water, avoiding both dry spots and hot spots that might appear in the traditional process.

At the end of the steeping process small rootlets emerge transforming barley into green malt with a consistent moisture content which can be adapted, based on the needs of the barley and the type of malt to be produced, by reducing or increasing the flooded period. The green malt is then transferred into the germination vessel where a sudden and vigorous increase in the metabolism of the grains undergoing the steeping phase using the new system is noticed. The fast germination allows no need for spraying or maximum 1 spraying step during germination versus 2 sprays with the traditional method. The ventilation system is very important during the germination step due to rapid increase in temperature as a result of the intense metabolism experienced by the well soaked kernel.

The advantages of this new malting method are reduced water consumption, reduced carbon footprint due to the limited amount of CO₂ produced during steeping as a result of the long flooded period, as well as reduced amount of effluent to be treated.

The new system brings consistency to the moisture content inside the grain at the end of the steep, with values of 42-43% moisture measured for six-rowed winter barley varieties. These values will imply a limited need of water in the next step of germination.

The goal of germination is to continue to produce enzyme inside the grain able to degrade all the rigid structures of the cereal, making it easy to use in food and beverage processes. One parameter that reflects the degree of modification of the kernel is represented by friability of malt.

Analysing the friability levels in case of the traditional method and the new method, it was noticed a different behaviour of the kernel, with a maximum moisture in germination of 44% producing higher friability levels than higher moisture (46% min) used in the traditional method.

The long steeping phase of up to 20 h in which the grain is continuously flooded, allows sufficient water uptake into the embryo and the endosperm part of the grain, without any risk of drying out that might lead to water loss from the endosperm towards the embryo with negative consequences on grain modification. As such the extract levels in the malted grains produced with the new method are higher compared with the malt obtained with the traditional way of working.

The new malting method insures high level of oxygen throughout the entire flooded steeping phase, being a perfect fit for the malting of water sensitive grains whose embryo requires increased oxygen levels to start germinating.

The malt produced with this method showed a lower level versus the traditional method of a group of aldehydes considered staling markers for beer. These aldehydes are associated with stale flavour formation in beer, with negative consequences on beer shelf life. Among the free aldehydes analysed a significant reduction has been measured for the Strecker degradation aldehydes when the new method has been used. The off-flavour given by the Strecker degradation products varies from grainy (2-methylpropanal) to fruity and malty (2-methylbutanal, 3-methylbutanal) as well as cooked potatoes (methional) or flowery (phenylacetaldehyde).

The low level of Strecker aldehydes in the malt obtained with the new method may be explained by the suppression of embryo development during the steeping phase under water as well as the removal of polyphenols from the steeping water, both actions reducing the formation of aldehyde precursors.

Another explanation might be related to the inhibition of the short-chain and branched-chain aminoacids catabolism influenced by the long period of the flooded phase during steeping. This can have a further positive effect on the brewing process with respect to reduced levels of vicinal diketones (diacetyl and 2,3-butandione) formation in green beer as there is limited need for de novo production of these aminoacids (valine and leucine) and subsequent reduced diacetyl rests and improved productivity in the breweries.

For six-rowed winter barley this hypothesis is supported by the fact that, while there is no significant difference between the level of nitrogen in malt with the new method and the traditional method, the pH level of the malt produced with the new method slightly increases.

One of the other parameters that showed improved results with the new method is related to the foam stability. One of the most important visual aspects of a beer is represented by the quality of the foam. This is the result of a combination of factors like stability, amount, the size of the bubbles, as well as compactness. A survey conducted in 2010 showed that consumers considered ideal 20 mm of foam after pouring the beer in the glass as well as a lacing of the glass after consumption.

A number of factors have a positive impact on foam stability, like the level of protein in the grain, polyphenols, iso-alfa-acids as well as products of Maillard reaction. Among the protein types in the grain, the most important impact upon foam formation and stability is given by the amount of proteins with a higher molecular weight than 5 kDa but also the amount of protein Z4. The latter is heat tolerant and can withstand the degradation by the proteolytic enzymes during germination.

The malt obtained with the new method has been tested using the Rudin method and indicated a good head retention in two-rowed spring malt versus the traditional method while the six-rowed malt indicated a foam more appealing for the customers, with condensed head and finer bubbles.

Although the present invention is elucidated above on the basis of the given drawings, it should be noted that this invention is not limited whatsoever to the embodiments shown in the drawings. The invention also extends to all embodiments deviating from the embodiments shown in the drawings within the scope of the invention defined by the appended claims.

1. Method for producing malt from cereals via steeping followed by germination and kilning, the steeping process comprises only one immersion step in which the cereals are immersed in water, during which immersion step the steeping water is continuously purified, characterized in that the purification comprises an adsorption process followed by an oxidation process, which adsorption process purifies the steeping water using a carrier material having a ceramic open structure to enable binding of non-charged polymeric organic molecules including a fraction of polyphenolic compounds and molecular compounds leaking from the grain in the water, and which oxidation process comprising injection of hydrogen peroxide and high concentrated oxygen into the water after the adsorption process and using a ceramic filter bed as carrier material with an immobilized catalyst on it for removing micro organisms, which catalyst comprises a complex of metal ions.

2. Method according to claim 1, characterized in that the complex of metal ions comprises one or more of the following ions: copper, iron, cobalt, palladium.

3. Method according to claim 1 or 2, characterized in that in the oxidation process the water enters at least one oxidation column (105) containing the ceramic filter bed with the immobilized catalyst via a perforated injection tube (109) extending vertically upwards in the oxidation column.
